(19) United States
(12) Patent Application Publication
(10) Pub. No.: US 2026/0251448 A1
(43) Pub. Date: Aug. 27, 2026

(54) Method and Radar Device for a Radar-Based Size Classification of Objects, and Correspondingly Designed Motor Vehicle

(71) Applicant: Bayerische Motoren Werke Aktiengesellschaft, Muenchen (DE)

(72) Inventors: Juan Carlos FUENTES MICHEL, Muenchen (DE); Stefan HOLZKNECHT, Feldkirchen (DE)

(21) Appl. No.: 18/992,333

(22) PCT Filed: Aug. 9, 2023
(86) PCT No.: PCT/EP2023/072094

§ 371 Date: Jan. 8, 2025

(30) Foreign Application Priority Data
Aug. 11, 2022 (DE) 10 2022 120 258.5

(51) Int. Cl. G01B 15/04; G01S 7/35; G01S 13/931

(52) U.S. Cl. CPC G01B 15/04; G01S 7/356; G01S 13/931

(57) ABSTRACT

A method for radar-based size classification of objects in a motor vehicle includes acquiring a radar signal that is reflected from an object in multiple receiving channels. The method also includes evaluating the acquired reflected radar signal with respect to a phase profile thereof across the multiple receiving channels. The method also includes classifying the as an extended object when a phase jump is present in the phase profile.

### BACKGROUND AND SUMMARY OF THE INVENTION

The present disclosure relates to a method and a radar device for radar-based size classification of detected objects. The disclosure furthermore relates to a correspondingly designed motor vehicle.

Radar systems in motor vehicles can be useful for detecting objects in respective surroundings. Radar systems can have some advantages here over other types of sensors, such as a longer effective range and an automatic accurate speed determination by utilizing the Doppler effect. However, conventional radar systems often have a limited angle resolution, so that in particular at longer distances, even extended objects, such as a rear side of a truck or the like, are only detected as a point object. A greater angle resolution, thus a more detailed separation of radar echoes from different points or areas of an extended object, could be achieved, for example, via a larger aperture of an employed radar antenna. However, this is not always practically possible due to restrictions in installation space and costs.

EP 2 215 497 B1 describes an angle-resolving radar sensor as a solution approach. This has an optical lens therein and an antenna element arranged spaced apart therefrom, which is movable relative to the lens in a direction transverse to the optical axis of the lens. The antenna element is movable here in a direction transverse to the optical axis of the lens together with an associated high-frequency module for generating a radar signal to be transmitted. A radar sensor is therefore to be provided which enables simple control of the directional characteristic and a high angle resolution with a simple structure.

EP 3 161 514 B1 describes a method for locating a radar target using an angle-resolving MIMO-FMCW radar sensor. Received signals are downmixed with the transmitted signal to form baseband signals and the angle of a located radar target is determined on the basis of amplitudes and/or phase relationships between baseband signals, which are obtained for different selections of antenna elements of the radar sensor used for transmitting and receiving. A time multiplexing method is thus to be specified for a MIMO radar, which permits more accurate angle estimation.

EP 2 270 541 B1 describes a method using a synthetic aperture for determining an angle of incidence and/or a distance of a sensor from an object in space, in which an echo profile is recorded at each of a number of aperture points. In particular, using the method therein, determining an angle of incidence independently of a distance to the object or transponder is to be enabled.

The object of the present disclosure is to enable improved radar-based surroundings detection in a particularly efficient manner.

This object is achieved by the subjects of the disclosure. Further possible embodiments of the disclosure are also disclosed in the description, and the figures. Features, advantages, and possible embodiments which are described in the context of the description for one of the subjects of the claims are to be viewed at least analogously as features, advantages, and possible embodiments of the respective subject matter of the other independent claims and any possible combination of the subjects of the independent claims, possibly in conjunction with one or more than one of the dependent claims.

The method according to the disclosure can be applied for radar-based size classification or size detection or size estimation of radar-based detected objects. In particular, the method according to the disclosure can be applied in a motor vehicle, but is not necessarily restricted to this application. A radar signal or radar pulse can be emitted in each case by means of a radar device or at least one radar emission antenna. This can be part of the method or can take place before the actual method according to the disclosure. In one method step of the method according to the disclosure, a resulting or corresponding radar signal reflected from an object is then acquired in multiple receiving channels or across multiple receiving channels. Such reception channels can be implemented, for example, by real and/or virtual receivers or receiving antennas, a virtual receiver array or antenna array, possibly using multiple transmitting antennas and/or the like. In the latter case, the number of the receiving channels can correspond to the multiplicative product of the number of the transmitting antennas and the number of the receiving antennas.

The acquisition of the reflected radar signal in the meaning of the present disclosure can mean or comprise, for example, its reception or measurement by means of at least one receiving antenna or radar device and/or tapping via a corresponding interface or a readout, for example, of corresponding raw data, from a data memory and/or the like.

In a further method step of the method according to the disclosure, the acquired reflected radar signal, thus in particular corresponding raw data acquired or present in the radar device used, is analyzed or evaluated with respect to its phase profile across the multiple receiving channels. The phase profile can be given by a sequence of phases or phase locations of corresponding individual signals. These individual signals can correspond here to the individual signals or signal parts of the individual receiving channels or in or from the individual receiving channels. Different phases or phase locations in different receiving channels can correspond, for example, to reflections of the radar signal at points or areas of the respective object at different depths, thus different distances from the radar device, and/or to reflections of the radar signal from the respective object at different angles of azimuth and/or elevation.

In a further method step of the method according to the disclosure, if at least one phase jump is present in the phase profile across the receiving channels or the individual signals, the respective object is classified as an extended object, thus in particular not as a point object. Such a classification as an extended object can mean, for example, that a predetermined minimum size is assumed or output for the object. The size of the respective object can also be estimated, for example, on the basis of the acquired radar signal or on the basis of the phase profile or the at least one phase jump, thus a corresponding object can be classified more accurately with respect to its size. For this purpose, for example, a predetermined assignment table, a predetermined model, or a predetermined algorithm and/or a correspondingly trained device of machine learning, such as a correspondingly trained artificial neural network or the like, can be used.

The present disclosure is thus based on the finding that the size of the remaining object can be concluded at least to a certain extent on the basis of the phase profile, thus ultimately the phase information contained or coded in any case in the radar signal acquired across the multiple receiving channels. Phase jumps, thus discontinuities in the phase profile across the multiple receiving channels, can in particular be characteristic here for extended objects. Therefore, in particular extended objects can be recognized, which do reflect the radar signal from multiple points or across a certain area, but cannot be resolved or recognized as an extended object-for example in the form of multiple radar detections associated with the same object-due to the limited angle resolution of the radar device used.

The individual receiving channels, thus corresponding individual signals of physical real and/or virtual receiving antennas, contain information about a respective receiving direction of the radar signal in its respective phase or phase location. A phase change or phase rotation, thus the phase profile across a lateral and/or vertical extension of the remaining object, can then generate a Fourier spectrum which is corresponding or characteristic for accordingly extended objects as a result of a Fourier transform of the acquired radar signal. Generating and analyzing or evaluating such a Fourier spectrum can be, for example, part of the evaluation of the respective radar signal with respect to the phase profile. If the individual phases or phase locations, thus a complex pointer of the acquired radar signal is not constant or does not vertically and/or laterally progress continuously over an extension of the real and/or virtual aperture of the radar device used, thus are rotated further, according to a finding underlying the present disclosure, this can indicate concealed targets or partial targets or subtargets or subobjects within an extended target or object, since corresponding different reflection points or areas which are arranged distributed over the respective object can each provide a contribution to the ultimately acquired radar signal. The corresponding evaluation of the individual, complex-valued receiving signals or individual signals from the receiving channels for deviations in the phase location, for example, with respect to a constant, thus equal phase or a continuous or linear phase profile can therefore indicate extended targets, thus objects.

A corresponding classification as an extended object- or, if no corresponding phase jump or no corresponding characteristic Fourier spectrum or the like is present as a point object-can then be used or taken into consideration in the further signal processing or data processing. For example, a further classification of the respective object can be carried out or checked for plausibility based thereon, for example even if the respective object cannot be recognized as an extended object on the basis of Doppler data or distance data determined based on radar or based on the angle resolution or angle separation of the radar device used alone. In the application of a motor vehicle, for example when driving behind a leading truck at a constant distance and at equal speed, this can thus be recognized or classified as a foreign vehicle based on the classification as an extended object obtained by means of the present method. This can enable a correspondingly improved and safer reaction, which is more appropriate for the respective situation, for example of one or more further assistance systems of the motor vehicle, for example for at least semiautomated vehicle guidance or the like.

The present disclosure can thus enable more detailed, accurate, or reliable surroundings recognition solely by way of improved processing or usage of radar signals acquired in any case, in particular without a larger antenna or a larger number of antennas being necessary for this purpose, for example, in comparison to conventional radar systems already presently available for motor vehicles.

In one possible embodiment of the present disclosure, multiple physical antennas or also a virtual antenna array is/are used for or as the multiple receiving channels. The multiple physical antennas can be or comprise multiple receiving antennas and/or multiple transmitting antennas. By means of multiple receiving antennas, multiple individual signals can accordingly be received directly, which correspond or can correspond to the individual receiving channels. By means of multiple transmitting antennas, a correspondingly adapted or varied radar signal can be transmitted, which can then be received using one or more physical receiving antennas. Multiple receiving channels can therefore also result, the number of which can correspond to the multiplicative product of the number of the transmitting antennas and the number of the receiving antennas. The phase profile can be acquired or evaluated here across the multiple real receiving antennas and/or across multiple virtual antennas of the virtual antenna array. A flexible adaptation of the antennas used as needed, thus the embodiment of the radar device used, can be enabled by the embodiment of the present disclosure proposed here and nonetheless the method according to the disclosure can be applied in correspondingly different variants or embodiments. The method according to the disclosure can then be applied, for example, in different conditions or applications, for example, in the case of a different amount of available installation space and/or different cost budgets or the like.

In one possible refinement of the present disclosure, the I & Q method (in-phase & quadrature method) and/or a Hilbert transform is applied in order to determine the phase locations of the individual receiving channels—and thus effectively the phase profile across them. The various phase locations, thus the phase profile, can therefore be ascertained by means of known methods directly from the acquired radar signal or corresponding raw data. The method according to the disclosure can therefore be implemented particularly easily and effectively.

In a further possible embodiment of the present disclosure, to detect a phase jump, it is checked whether the phase locations grow or change uniformly or constantly, thus consistently with point objects or individual detections for separate objects, in each radar detection and/or in each Doppler class, thus Doppler bin. In particular, a comparison to a predetermined threshold value can be carried out here. An object can then be classified as an extended object if a phase change, thus a phase jump between two different receiving channels, is greater than the predetermined threshold value or the phase profile deviates by at least the predetermined threshold value from a constantly or uniformly growing phase profile. To determine the phase locations, available data can be taken or recovered from a respective radar cube, thus a typical three-dimensional data structure containing received radar signals or radar data. This can relate in particular to data before they are transformed, thus further processed, by means of a Fourier transform, in particular a fast Fourier transform, to determine or resolve angles at or below which the radar detections or the objects associated with them appear from the viewpoint of the radar device used. On the basis of the angle determined by means of such a Fourier transform, however, a corresponding object or detection assignment of the acquired radar data can then be carried out in order to be able to ascertain the phase profile reliably per object. The embodiment of the present disclosure proposed here is based on the fundamental finding that in this manner extended objects can be recognized as such in a radar-based manner, even if they are not recognized in a conventional manner as extended objects, for example, due to their distance from the radar device and/or the limited angle resolution or angle separation of the radar device.

In a further possible embodiment of the present disclosure, at least one Fourier transform, in particular at least one fast Fourier transform (FFT) is applied to the acquired radar signal, in order to determine a respective detection angle for the object or per object or per radar detection in which the respective corresponding object, which is thus responsible for the respective radar detection or for the acquired radar signal, is located from the viewpoint of the radar device used. Furthermore, a breadth of a resulting spectrum, which thus results as the product of the Fourier transform, or a central peak or main peak of this resulting spectrum is then determined. From this breadth or based on this breadth, the size of the respective object is then derived or estimated. This can be carried out, for example, according to the angle difference corresponding to the breadth in consideration of a distance to the respective object also ascertained on the basis of the radar signal, by means of a predetermined assignment table between breadth of the spectrum and size or extension of the object, by means of a corresponding predetermined model or algorithm, by means of a correspondingly trained device of machine learning, and/or the like. The embodiment of the present disclosure proposed here enables a particularly low-effort and efficient implementation and application of the method according to the disclosure. The Fourier transform can be carried out, for example, in any case in the context of conventional data or signal processing of radar devices, in order to determine the detection angles, thus to spatially locate the detected objects. The breadth of the resulting spectrum can then be ascertained with particularly little additional computing effort.

In a further possible embodiment of the present disclosure, a statistical evaluation is carried out during the evaluation of the acquired reflected radar signal. At least one predetermined statistical measure is ascertained and used, thus taken into consideration, to detect a phase jump. In particular a standard deviation of phases or phase locations across the receiving channels can be ascertained as such a statistical measure. This standard deviation or these standard deviations can then be compared to the predetermined threshold value. A phase jump can be detected- and the respective object can accordingly be classified as an extended object-in this case if the predetermined threshold value is reached or exceeded. A statistical evaluation proposed here can be implemented and carried out particularly easily and flexibly enable a rapid, robust, and reliable recognition of extended objects, thus a corresponding size classification.

In one possible refinement of the present disclosure, a value course of the determined statistical measure is ascertained for the respective object across multiple acquired radar signals from multiple radar measurement cycles and taken into consideration for the classification of the respective object. This is typically readily possible, since detected objects -independently of the size classification-typically are or can be tracked, thus traced, in a radar-based or sensor-based manner, for example. An object can only be classified as an extended object, for example, if the value course is consistent, thus, for example, the statistical measure indicates an extended object in each case across multiple radar measurement cycles, thus, for example, the predetermined threshold value mentioned at another point is exceeded repeatedly or continuously. A particularly robust and reliable size classification can be achieved by the embodiment of the present disclosure proposed here, since therefore, for example, outliers, incorrect measurements, interfering influences, or the like, which are individual or brief in comparison to the overall duration of multiple, in particular successive radar measurement cycles, cannot determine or change the size classification.

In a further possible embodiment of the present disclosure, the acquired reflected radar signal and/or data derived therefrom are provided or supplied to a device of machine learning, which is trained for the size classification of objects based thereon, as an input, thus as input data. Such a device of machine learning can in particular be or comprise an artificial neural network or the like. Data derived from the radar signal can be or comprise, for example, the phase profile and/or the statistical measure mentioned at another point and/or the like. Based on the provided or supplied input data, the respective object is then classified by the trained device of machine learning with respect to its size, thus in particular either as an extended object or as a non-extended object or point object. The device of machine learning can also estimate the size in each case of at least one extended object more accurately, for example, by a classification into one of multiple predetermined different size classes or the like.

The embodiment of the present disclosure proposed here is based on the finding that information or patterns, which can be dependent on the size or extension of the respective object, can be contained or coded in the reflected radar signal acquired across the multiple receiving channels. A radar signal reflected from an extended object can thus have characteristic properties for such an extended object, which can differ from properties characteristic for point objects. This information or these patterns can be difficult to define exactly or to recognize, but are learned automatically and particularly robustly and completely by means of machine learning. A correspondingly robust and reliable size classification can therefore be carried out by the correspondingly trained device of machine learning.

The size classification of objects proposed here by means of a trained device of machine learning can be particularly precise in particular for marginal cases, for example, in comparison to other methods. In addition, however, such another method, for example, an evaluation via Fourier transform or the like can be carried out. Such another method can for example, enable particularly reliable size classification for standard cases or generic cases and/or can function as a safeguard or plausibility check for the size classification output by the device of machine learning. If multiple methods for size classification, thus, for example, a method based on machine learning and a method based on a Fourier transform, are applied for the size classification, their results can be combined with one another. For this purpose, for example, a maximum likelihood classification or weighting or the like can be applied. By way of a combination of multiple methods for the size classification, it can ultimately be carried out particularly robustly and reliably.

The present disclosure also relates to a radar device, in particular for a motor vehicle. The radar device according to the disclosure has a signal device or also data processing device and is configured to carry out the method according to the disclosure, in particular automatically. For this purpose, the radar device or the signal or data processing devices, for example, can have a corresponding circuit and/or a processor device, such as a microchip, microprocessor, microcontroller, or the like, with a computer-readable data memory coupled thereto. A corresponding operating or computer program and/or possibly the artificial neural network mentioned at another point or the like can then be stored in this data memory, for example. The operating or computer program can code or implement the method steps, measures, or sequences or corresponding control instructions mentioned in conjunction with the method according to the disclosure and can be executable by means of the processor device, in order to cause the method according to the disclosure to be carried out. The radar device according to the disclosure can also have at least one radar antenna and possibly a signal generating device. The radar device according to the disclosure can thus in particular be the radar device mentioned in conjunction with the method according to the disclosure or the radar system mentioned in conjunction with the method according to the disclosure or can correspond thereto.

The present disclosure also relates to a motor vehicle which has a radar device according to the disclosure. The motor vehicle according to the disclosure can also have at least one antenna or at least one radar transmitter and receiver, if it is not part of the radar device. The motor vehicle according to the disclosure can thus be designed to carry out the method according to the disclosure. In particular, the motor vehicle according to the disclosure can be the motor vehicle mentioned in conjunction with the method according to the disclosure or in conjunction with the radar device according to the disclosure or can correspond thereto.

Further features of the disclosure can result from the claims, the figure, and the description of the figure. The features and combinations of features mentioned above in the description and the features and combinations of features shown hereinafter in the description of the figures and/or solely in the figures are usable not only in the respective specified combination, but also in other combinations or alone, without departing from the scope of the disclosure.

### BRIEF DESCRIPTION OF THE DRAWING

FIG. 1 shows a schematic representation having a motor vehicle which is designed for radar-based recognition of objects in the surroundings.

### DETAILED DESCRIPTION OF THE DRAWING

Conventional vehicle radars detect a point target, such as a sphere, at its geometrical center in vertical and lateral extension. Real extended targets, such as a vehicle rear side of a leading vehicle, are conventionally only resolved into more than one target by a radar of a following vehicle if a separation via Doppler speed or distance or an angle separation can take place vertically and laterally. However, the first two criteria are generally disqualified, for example, during a drive toward or following a vehicle rear wall in spite of struts or similar structures. The lateral and vertical angle separation capability of conventional vehicle radars is also not sufficient depending on the longitudinal distance in the direction of travel in order to represent more than one point or more than one point target. In fact, however, in a vehicle radar having multiple receivers, in principle the information about a breadth or extent of the respective target can be present.

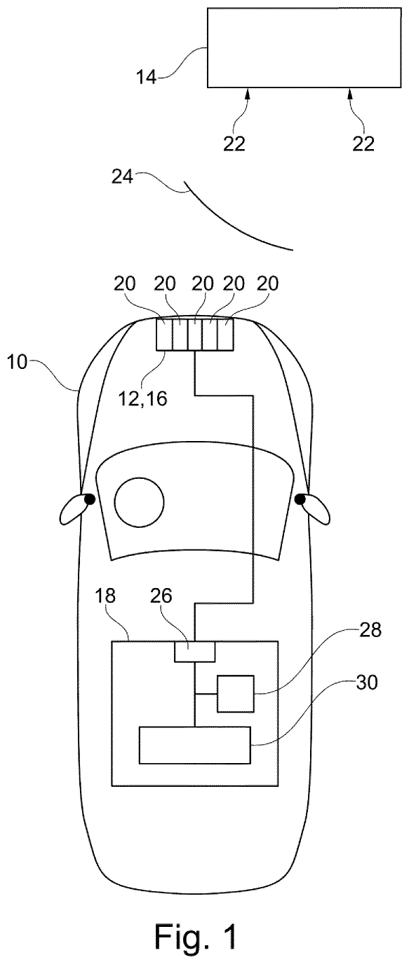

To explain making this information useful, FIG. 1 shows an exemplary schematic overview illustration of a motor vehicle 10 equipped with a radar system 12. A target present in an acquisition area of the radar system 12, which is designated here as an object 14, can be detected thereby.

The radar system 12 comprises an antenna device 16 and a data or signal processing device 18, which is only schematically indicated here. The antenna device 16 can acquire signals in multiple receiving channels 20, which are schematically indicated here. A radar pulse emitted by means of the antenna device 16 can thus be reflected at the extended object 14 at various points 22. A corresponding reflected radar signal 24 is also schematically indicated here. The reflected radar signal 24 can then be acquired in the multiple receiving channels 20, which then each supply an individual signal.

These individual signals from the individual receiving channels 20 contain information about a respective receiving direction, from which or in which the radar signal 24 has reached the respective receiving channel 20, in a phase or phase location of the respective individual signal. A corresponding phase profile thus results across the multiple receiving channels 20.

Such a phase profile or a corresponding phase rotation across the lateral and/or vertical extension of the object 14 can generate a corresponding or characteristic spectrum after a Fourier transform of the acquired radar signal 24 or the individual signals, which can be carried out, for example, by the signal processing device 18. A corresponding analysis with respect to the phase profile can then be carried out by the signal processing device 18. For this purpose, the signal processing device 18 can acquire the individual signals from the receiving channels 20, for example, via an interface 26 and process them by means of a processor 28 and a data memory 30. A possibly existing phase jump, thus a deviation in the phase or phase location of various individual signals from various receiving channels 20 can be detected thereby. Such phase jumps or deviations can indicate a certain extension of the object 14.

Accordingly, the object 14 can be classified as an extended object upon detection of a corresponding phase jump or a corresponding deviation of the phases or phase locations of the individual signals from one another.

The phases or phase locations of the individual, complex-valued reception signals or individual signals from the various receiving channels 20 can be immediately available or ascertained, for example, by means of the I & Q method or after application of a Hilbert transform or the like. Corresponding data can then be removed or recovered from the radar cube, for example, even before application of a Fourier transform for the detection angle determination. Based thereon, it can then be checked per detection in the respective acquisition area and/or, for example, per Doppler bin whether the phases or phase locations of the individual signals are equal, have a constant growth, thus a constant increase across the receiving channels 20, or display deviations therefrom. Mathematical methods known per se can be applied for this purpose, such as a determination of the breadth of the spectrum resulting from the Fourier transform, statistical methods, such as an ascertainment of a standard deviation of the phase locations across the receiving channels 20, and/or the like. A corresponding statistical measure can also be ascertained across multiple measurement or radar cycles based on an automatic tracking of the respective object 14.

The approach described here can combat the problem that typically for separation or separate recognition, targets, for example, the various points 22 of the object 14 here, have to be spatially spaced apart from one another enough that corresponding spectra can be clearly distinguished from one another. However, since the fast Fourier transform as well as other time range transformation methods are subject to a certain windowing, for example, due to a limited measuring time and a frequency uncertainty or uncertainty in the spectrum resulting therefrom, a spectrum having a certain breadth or peak breadth always results even for a single frequency as the transform. Further peaks actually present in addition to a main peak can thus be covered by the breadth of the main peak and therefore no longer resolved or detected. A method for classifying laterally and/or vertically extended targets by means of radar can also be successfully applied in such situations by the utilization of phase information described here, in order to recognize extended targets or distinguish them from actual point targets.

### LIST OF REFERENCE SIGNS

10 motor vehicle
12 radar system
14 object
16 antenna device
18 signal processing device
20 receiving channels
22 points (of the object 14)
24 radar signal
26 interface
28 processor
30 data memory

1.-10. (canceled)

11. A method for radar-based size classification of objects in a motor vehicle, comprising:
acquiring a radar signal that is reflected from an object in multiple receiving channels;
evaluating the acquired reflected radar signal with respect to a phase profile thereof across the multiple receiving channels; and
classifying the object as an extended object when a phase jump is present in the phase profile.

12. The method according to claim 11, further comprising:
using multiple physical antennas or a virtual antenna array in association with the multiple receiving channels.

13. The method according to claim 12, further comprising:
applying an I & Q method and/or a Hilbert transform to determine phase locations of individual receiving channels.

14. The method according to claim 13, further comprising:
checking whether the phase locations grow uniformly per radar detection and/or per Doppler class, via a comparison to a predetermined threshold value, to thereby detect the phase jump.

15. The method according to claim 11, further comprising:
applying a Fourier transform to the acquired radar signal in order to: i) determine a detection angle, ii) ascertain a breadth of a resulting spectrum, and iii) derive a size of the object.

16. The method according to claim 11, further comprising:
carrying out a statistical evaluation in the step of evaluating the acquired reflected radar signal, wherein at least one predetermined statistical measure, including at least a standard deviation of phase locations across the receiving channels, is ascertained and used to detect the phase jump.

17. The method according to claim 16, wherein
a value course of the at least one predetermined statistical measure for the object is ascertained across multiple acquired reflected radar signals from multiple radar measurement cycles and taken into consideration for the classification of the object.

18. The method according to claim 17, further comprising:
providing, the acquired reflected radar signal and/or data derived therefrom, to a machine learning device trained for size classification of objects as input data, and
classifying the object with respect to its size by the machine learning device.

19. A radar device for a motor vehicle comprising:
a signal processing device, wherein the radar device is configured to carry out a method according to claim 11.

20. A motor vehicle comprising:
the radar device according to claim 19.
